(19) United States
(12) Patent Application Publication
(10) Pub. No.: US 2007/0215094 A1
(43) Pub. Date: Sep. 20, 2007

(54) Nagata cycle rotary engine

(76) Inventors: Sumiyuki Nagata, Kashima City (JP); Ryan William Cobb, Lima, OH (US)

Correspondence Address: Ryan Cobb, 2464 Penny Lee Drive, Lima, OH, 45805, US

(21) Appl. No.: 11/713,991

(22) Filed: Mar. 5, 2007

(30) Foreign Application Priority Data
Mar. 6, 2006 (JP) 2006-102445

(51) Int. Cl. F02B 53/00

(52) U.S. Cl. 123/243

(57) ABSTRACT

An internal combustion rotary engine using vanes to create separate combustion chambers within the engine and capable of performing all four strokes of the Otto cycle (intake, compression, combustion and exhaust) in each separate combustion chamber. Each Otto cycle is completed in a 180-degree rotation with all four strokes of the Otto cycle being completed in 720 degrees. An intake and exhaust valve system tightly controls the flow of the air/fuel mixture into each separate combustion chamber.

Reference Japan Patent Application No. 2006-102445 filed Mar. 6, 2006

Small entity status claimed under 35 USC 41

### FIELD OF THE INVENTION

This invention relates to rotary internal combustion engines, pumps and compressors.

### DESCRIPTION OF THE PRIOR ART

Since its invention in the 1950's the rotary engine has not enjoyed wide-spread production or success. The first mass produced rotary engine was the Wankel Rotary Engine (1950). It was invented as an alternative to the piston engine. The main advantage of the rotary engine is its compact and efficient layout.

Since the invention of the original rotary engine several of the problems plaguing the design have been corrected. One such improvement is the apex seal which serves to reduce friction and fuel loss. Although several of the problems with the rotary engine have been corrected, significant ones still exist.

Historically, rotary engines have been plagued by several problems. Leakage under pressure has been an issue with designs since Ramelli first invented the rotary pump in 1588. Later internal combustion designs all had overheating as a common design fault. In the 1970's, General Motors abandoned an ambitious rotary engine project due to strict new environmental regulations on vehicle emissions. Additionally, rotary engines have had gas mileage far below the industry standard and are notorious for needing major engine seal repairs. Three main areas of concern are common to all rotary engine designs:

(a) Friction—because of their high rotational speed rotary engine designs create considerable centrifugal force resulting in friction.

(b) Sealing—chamber leakage under pressure wastes fuel and reduces engine efficiency.

(c) Durability—the two previous flaws add to the general wear and tear a combustion engine normally encounters to make durability a major concern.

Another problem specific to the technology presented herein is with vanes which serve to create separate chambers within an engine. Vanes are a common component in pumps and compressors but have not found success in combustion engines due to durability and sealing issues. Vanes can bend or even break under the high pressure and combustion they must endure in a combustion engine environment.

### SUMMARY OF THE INVENTION

Accordingly, the previous disadvantages are remedied in our current invention. Several objectives and advantages of the invention are:

(a) to provide an engine with reduced engine friction;

(b) to provide an engine that is relatively easy to manufacture;

(c) to provide an engine that is comprised of few parts;

(d) to provide an engine that is smaller and more compact than existing designs;

(e) to provide an engine that conserves the fuel/air mixture.

Further objectives and advantages are to provide an engine that, because of the above listed objectives and advantages, will allow for superior gas mileage and performance.

### BRIEF DESCRIPTION OF THE DRAWINGS

FIG. 1 shows an end view of an engine design with four chambers and incorporating an eccentric shaft. In this depiction, the rotor is in slideable contact with the vanes ( ) via the vane pins. This version incorporates a timing belt/chain to activate the valves.

FIG. 2 shows a side view of the same four chamber design as depicted in FIG. 1 with vane channels on the interior surfaces of each end housing.

FIG. 3 depicts a side view the same four chamber engine as FIG. 1 as it orbits the driveshaft and displaces each chamber.

FIG. 4 shows an end view of a possible variation of the design FIG. 1 with five chambers and a front and end view of a vane.

FIG. 5 shows an end view of a possible variation of the design in FIG. 1 with six chambers and vanes with wishbone supports.

FIG. 6 shows an end view of a five chamber engine design with “T” or “L” shaped vanes. In this depiction vanes slide in and out of recesses in the rotor and also travel along channels on the interior surface of the side housing.

FIG. 7 depicts an end view the same five chamber engine as FIG. 6 as it orbits the driveshaft and displaces each chamber.

FIG. 8 shows an end view of a possible variation of the design in FIG. 6 with five chambers and “T” or “L” shaped which move in and out of recesses on the periphery of the rotor.

FIG. 9 shows an end view of a possible variation of the design in FIG. 6 with four chambers and vanes with wishbone supports.

FIG. 10 shows an end view of a four chamber engine with an outer and an inner rotor.

FIG. 11 depicts a side view the same four chamber engine as FIG. 10 as it orbits the driveshaft and displaces each chamber.

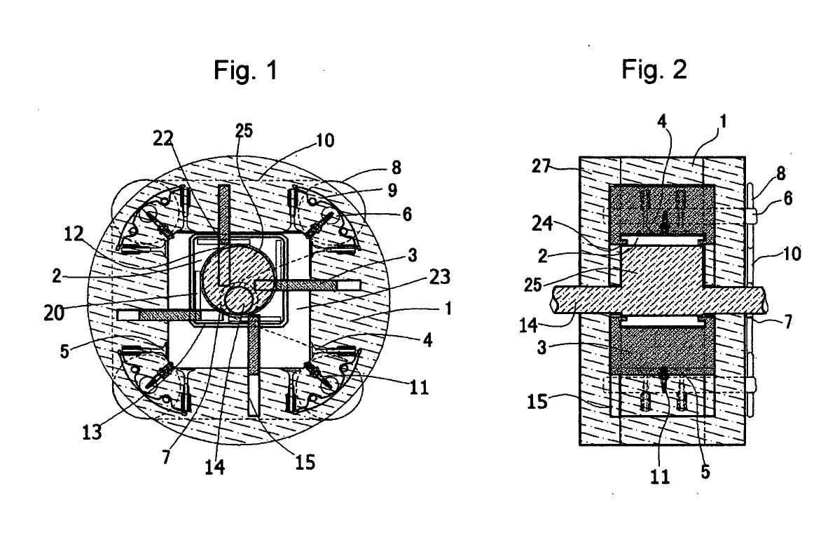

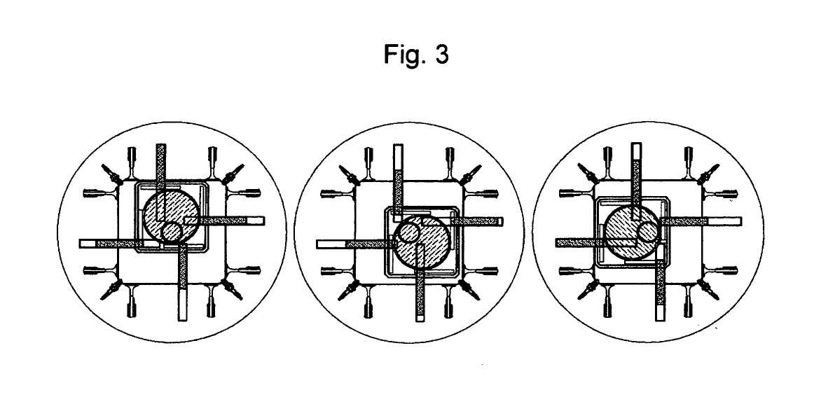

### DETAILED DESCRIPTION OF THE INVENTION

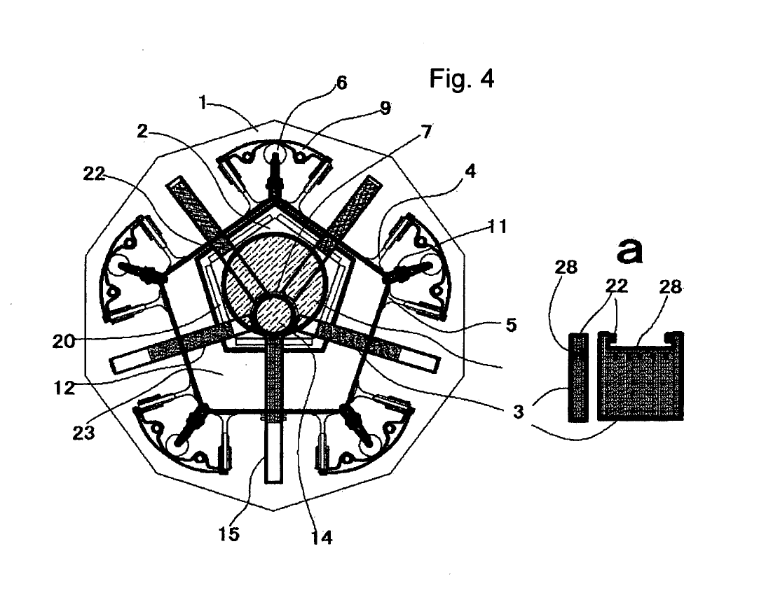

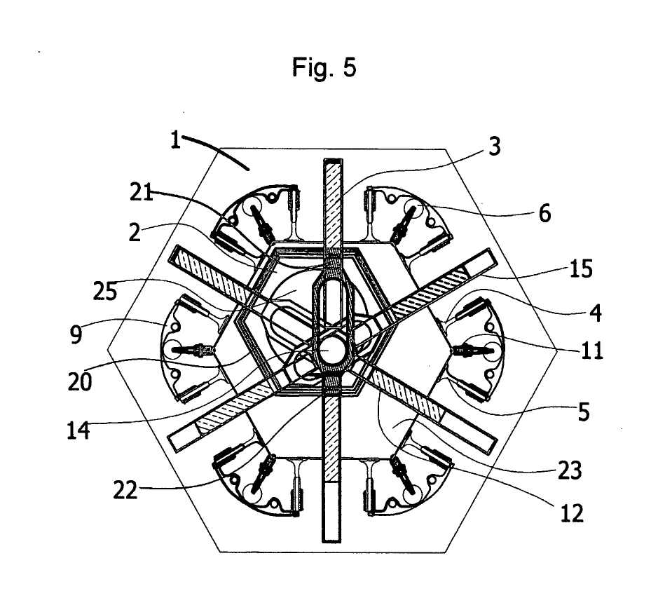

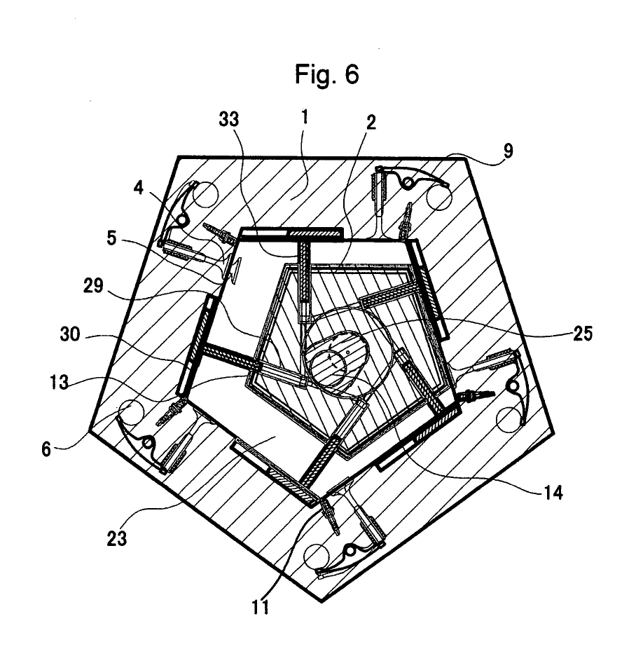

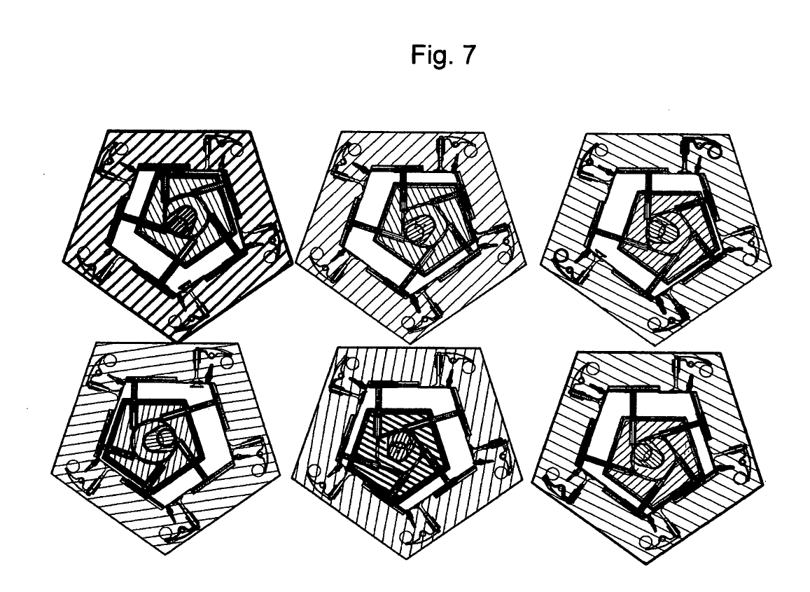

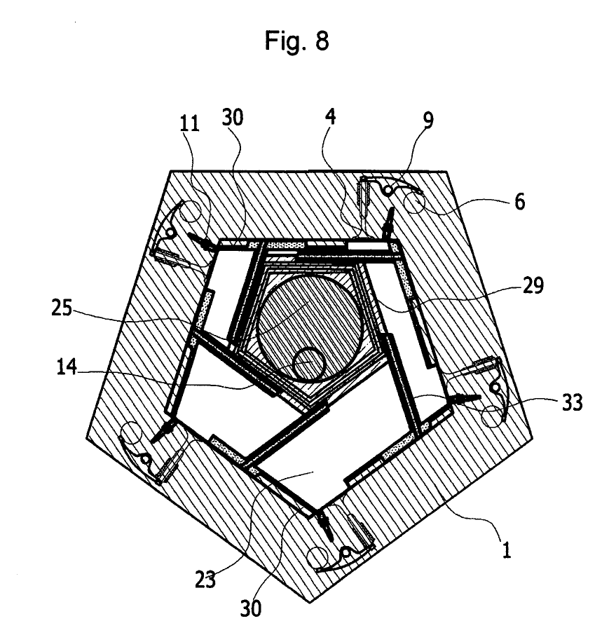

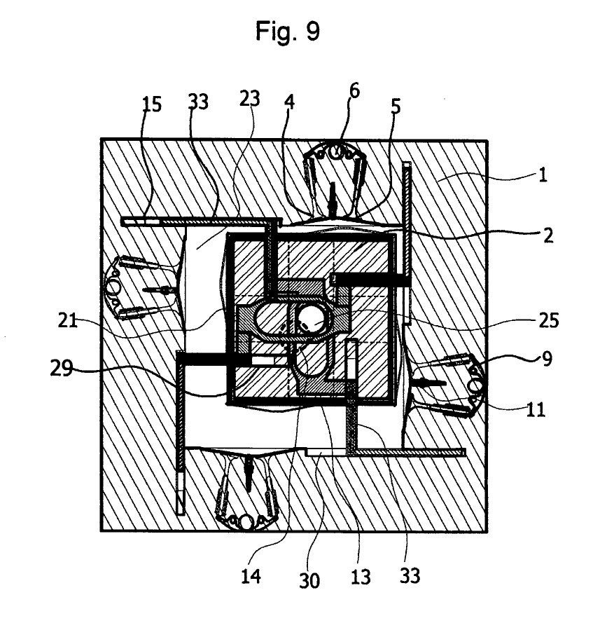

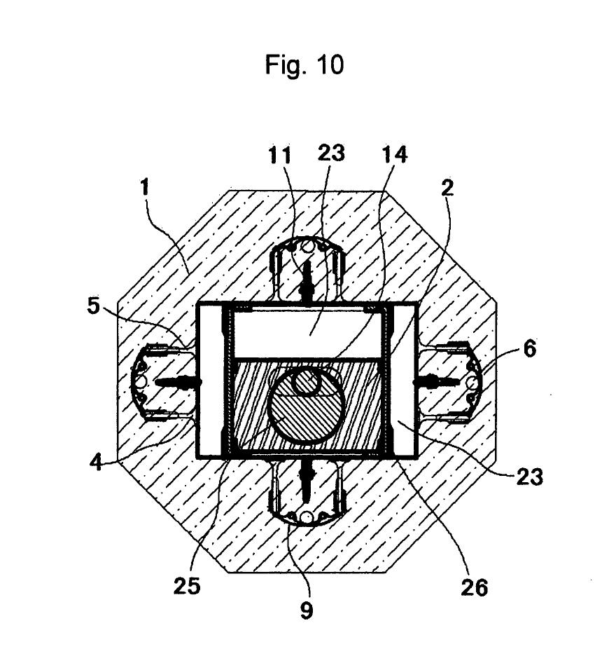

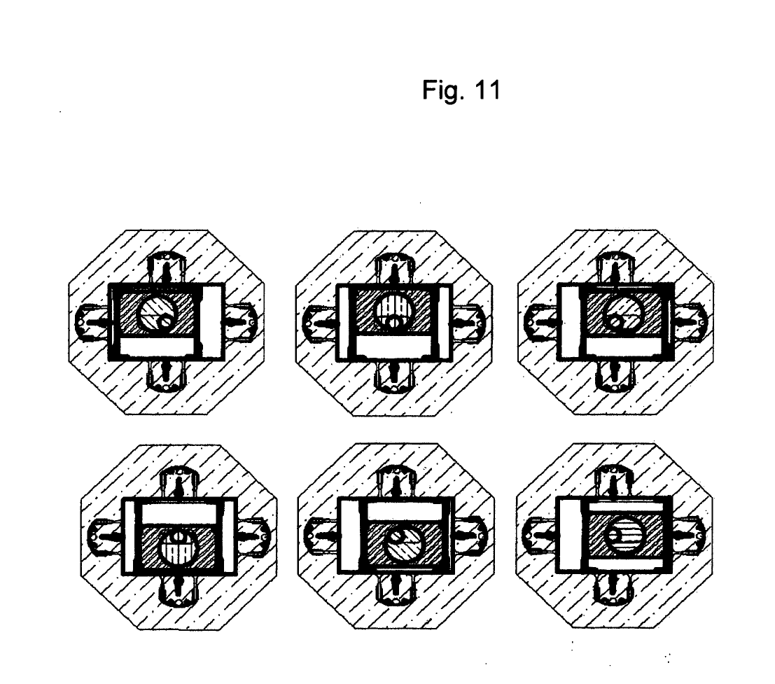

An embodiment of the present invention is illustrated in FIG. 1. Additionally, FIGS. 4 and 5 depict possible embodiments with different shapes and numbers of working engine chambers.

The engine has housing (1), which in this case has an inner wall which is a four sided polygon. Rotor (2), which in this case is also a four sided polygon, is contained inside housing (1) and is positioned off-center of drive shaft (14), allowing it to displace the fuel/air mixture about the engine chamber.

Vanes (3) extending between rotor (2) and the inner wall of housing (1) create separate chamber rooms (23) within the engine and are supported on each end by either rotor-side vane pins (22) or the vane recess (15) they slide in and out of in the side housing. Vane motion is restricted to rolling freely along vane channels (12) located in the inner wall of each end housing. Vane pin slots (20) located around the periphery of rotor (2) allow the rotor to be in slideable contact with the vanes (3) via the vane pins (22) with the combination allowing both parallel movement and movement towards and away from the housing inner wall.

Fuel/air mixture enters each engine chamber (23) through intake valve (4). Valve springs apply constant pressure on each valve to keep it closed. The motion of rotor (2) then compresses the fuel/air mixture and combusts it using sparkplug (11) Expended gas is then purged through exhaust valve (5). Combustion causes rotor (2) to orbit the central axis of the inner chamber of housing (1). This motion is converted to rotational energy with eccentric shaft (5), causing drive shaft (14) to rotate as the action is repeated in another chamber.

For every two rotations of rotor (2), the camshaft rotates once. As the camshaft rotates, it moves cam (6), which in turn acts to manipulate rocker arm (9). It is this manipulation of rocker arm (9) which causes intake valves (4) and exhaust valves (5) to open and close in each chamber room (23).

The opening and closing of the aforementioned valves replenishes the fuel/air mixture inside each separate chamber room (23). In this embodiment, the fuel/air mixture travels through an intake port and then travels through intake valve (4) and is drawn into the air-tight chamber room (23) created by rotor (2), vane (3), vane channel (12), vane recess (15) and the inner wall of housing (1). After combustion, the spent gas leaves the chamber through exhaust valve (5) into exhaust ports. From there the spent gas exits the engine.

Instead of using gears in this process, other possible variations of this design include using belts, chains, or nuts to rotate the camshaft and manipulate cam (6).

In this embodiment, any number of three or more vanes (3) can be incorporated to allow for any number of three or more chamber rooms (23). Any number of three or more intake valves (4) and exhaust valves (5) may also be used. To reduce friction, a ball bearing or similar system can easily be installed for the vanes (3). Furthermore, a crank and camshaft can accomplish the same vane (3) manipulation

Given that the point where rotor (2) comes closest to the chamber wall in each combustion chamber represents 0 degrees, with spark plug (11) being located at 0 degrees, 180 degrees marks the point where rotor (2) is furthest from the inner wall of housing (1).

From 0 degrees to 180 degrees, intake valve (4) is open. As intake valve (4) opens, the fuel air mixture enters the engine chamber.

From 180 degrees to 360 degrees, intake valve (4) is closed and no fuel air mixture enters engine chamber (23). At this time, the fuel air mixture in the chamber is compressed as rotor (2) moves toward the engine chamber wall. As rotor (2) nears a complete 360-degree cycle and the fuel air mixture is at its highest point of compression, spark plugs (11) ignite. This combustion causes a rapid increase in chamber pressure, causing rotor (2) to orbit the central axis of the housing inner chamber. This process occurs from 360 degrees to 540 degrees. After this point, exhaust valve (5) opens, and the spent gas is purged through the exhaust port. This purging process occurs from 540 degrees to 720 degrees, after which the four stroke cycle repeats.

Explanation of Four Engine Strokes:

Stroke one—Intake process 0-180 degrees

Stroke two—compression process 180-360 degrees=1 rotation

Stroke three—combustion process 360-540 degrees

Stroke four—purge process 540-720 degrees=2 rotations

This invention achieves the same results in two rotations as does a conventional four-stroke internal combustion piston engine.

Accordingly, the reader will see that the invention described here has numerous advantages over existing designs. This design will reduce friction with its orbit motion, improve sealing with its channeled vanes and will improve durability by decreasing the impact of the previous two factors on the internal combustion system. Additionally, the advantages described below will allow for superior gas mileage and performance in that this invention;

(a) reduces engine friction;

(b) is relatively easy to manufacture;

(c) is comprised of few parts;

(d) is smaller and more compact than existing designs;

(e) conserves the fuel/air mixture.

Although the description above contains many specifics, these should not be construed as limiting the scope of the invention but as merely providing illustrations of some of the presently preferred embodiments of the engine. For example, the engine can have any number of valves per chamber, a different shaped rotor, an inner-casing which does not have flat surfaces (such as slightly concave), etc.

Thus the scope of the invention should be determined by the appended claims and their legal equivalents, rather than by the examples given.

### PART LIST

1) Housing
2) Rotor
3) Vane
4) Intake valve
5) Exhaust valve
6) Cam
7) Drive shaft timing gear
8) Cam timing gear
9) Rocker arm
10) Timing belt
11) Spark plug
12) Vane channel
13) Rotor seal
14) Drive shaft
15) Vane recess
16) Unused
17) Unused
18) Unused
19) Inner rotor
20) Vane pin slot
21) Dual vane support shaft
22) Vane pin
23) Engine chamber
24) Vane seal
25) Eccentric shaft or crank shaft
26) Outer rotor
27) End housing
28) Vane seal
29) Vane recess
30) Vane guide
33) “T” or “L” shaped vane

What is claimed is:

1. A rotary internal combustion engine comprising:
a housing means defining a chamber having a polygonal shaped interior surface and ends and a central axis passing there-through,
driveshaft means rotationally mounted in the housing means,
a polygonal shaped rotor positioned off-center of the central chamber axis,
an eccentric member or crankshaft secured to said driveshaft means for converting orbit motion of said rotor into shaft rotational energy,
said rotor having surfaces in each said combustion chamber and movable in all four Otto cycles relative to each said combustion chamber,
a plurality of vanes disposed about said rotor creating three or more separate combustion chambers within the engine,
vane channels disposed about the end housings restrict the movement of said vanes,
vane recesses disposed about the side housing allow said vanes to move in and out of the housing means,
means for providing a combustible air and fuel mixture to each said combustion chamber,
intake and exhaust valve means for each said combustion chamber mounted on the housing means for controlling the flow of said air and fuel mixture into and out of said combustion chambers,
said vanes being located between each set of intake and exhaust valve means,
said intake and exhaust valve means having at least one intake and exhaust valve set in communication with each said combustion chamber,
means for operating said intake and exhaust valves in timed relation with the orbit motion of said rotor to allow said air and fuel mixture to flow into each said combustion chamber and allow exhaust gases to flow out of each said combustion chamber,
a fuel ignition means in communication with each said combustion chamber operable to ignite the fuel in said combustion chamber to thereby cause said rotor to have orbital movement and rotate the driveshaft.

2. The engine of claim 1 wherein exists a plurality of vane pairs, each vane pair being movable relative to the drive shaft and having a middle portion disposed about said drive shaft, and each vane pair having two exterior vane portions substantially disposed along a diameter of the rotor.

3. A rotary internal combustion engine comprising:
a housing means defining a chamber having a polygonal shaped interior surface and ends and a central axis passing there-through,
driveshaft means rotationally mounted in the housing means,
polygonal shaped rotor positioned off-center of the central chamber axis,
an eccentric member or crankshaft secured to said driveshaft means for converting orbit motion of said rotor into shaft rotational energy,
said rotor having surfaces in each said combustion chamber and movable in all four Otto cycles relative to each said combustion chamber,
a plurality of vanes disposed about said rotor creating three or more separate combustion chambers within the engine,
vane guides disposed about the side housing restrict the movement of said vanes,
vane recesses disposed about the rotor allow said vanes to move in and out of the rotor means,
means for providing a combustible air and fuel mixture to each said combustion chamber,
intake and exhaust valve means for each said combustion chamber mounted on the housing means for controlling the flow of said air and fuel mixture into and out of said combustion chambers,
said vanes being located between each set of intake and exhaust valve means,
said intake and exhaust valve means having at least one intake and exhaust valve set in communication with each said combustion chamber,
means for operating said intake and exhaust valves in timed relation with the orbit motion of said rotor to allow said air and fuel mixture to flow into each said combustion chamber and allow exhaust gases to flow out of each said combustion chamber,
a fuel ignition means in communication with each said combustion chamber operable to ignite the fuel in said combustion chamber to thereby cause said rotor to have orbital movement and rotate the driveshaft.

4. The engine of claim 3 wherein vane guides disposed about the rotor restrict the movement of said vanes, and
vane recesses disposed about the side housing allow said vanes to move in and out of the rotor means.

5. The engines of claims 3 and 4 wherein exists a plurality of vane pairs, each vane pair being movable relative to the drive shaft and having a middle portion disposed about said drive shaft, and each vane pair having two exterior vane portions substantially disposed along a diameter of the rotor.

6. A rotary internal combustion engine comprising:
a housing means defining a chamber having a four-sided polygonal shaped interior surface and ends and a central axis passing there-through,
driveshaft means rotationally mounted in the housing means,
a four-sided polygonal shaped outer rotor positioned off-center of the central chamber axis creating separate combustion chambers within the engine,
a four-sided polygonal shaped inner rotor positioned off-center of the central chamber axis creating separate combustion chambers within the engine,
an eccentric member or crankshaft secured to said driveshaft means for converting orbit motion of said outer and inner rotors into shaft rotational energy,
said outer and inner rotors having surfaces in each said combustion chamber and movable in all four Otto cycles relative to each said combustion chamber,
means for providing a combustible air and fuel mixture to each said combustion chamber,
intake and exhaust valve means for each said combustion chamber mounted on the housing means for controlling the flow of said air and fuel mixture into and out of said combustion chambers,
said intake and exhaust valve means having at least one intake and exhaust valve set in communication with each said combustion chamber,
means for operating said intake and exhaust valves in timed relation with the orbit motion of said rotor to allow said air and fuel mixture to flow into each said combustion chamber and allow exhaust gases to flow out of each said combustion chamber,
a fuel ignition means in communication with each said combustion chamber operable to ignite the fuel in said combustion chamber to thereby cause said rotor to have orbital movement and rotate the driveshaft.

7. The devices of claims 1 through 6 wherein a means for combustion is absent and they function as a pump or compressor.
